(19) United States
(12) Patent Application Publication
(10) Pub. No.: US 2007/0108838 A1
(43) Pub. Date: May 17, 2007

(54) REGENERATIVE BRAKING CONTROL SYSTEM AND METHOD

(75) Inventors: Aric Shaffer, Ypsilanti, MI (US); Michael Schneider, Bloomfield Twp., MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/164,195

(22) Filed: Nov. 14, 2005

(51) Int. Cl. B60T 8/64

(52) U.S. Cl. 303/152

(57) ABSTRACT

A system and method for controlling a regenerative braking system includes determining that at least a first wheel of a vehicle is experiencing a wheel slip event. The method also includes compensating, at a determined rate, the braking torque applied to the second wheel, upon determining whether the first wheel of the vehicle is experiencing the wheel slip event.

### TECHNICAL FIELD

The present invention relates generally to a system and method for operating a hybrid electric vehicle, and in particular to controlling regenerative braking for a hybrid electric vehicle.

### BACKGROUND

Regenerative braking systems seek to recover the kinetic energy of a vehicle, which is normally dissipated as heat by conventional hydraulic friction braking systems. The recovery of the kinetic energy occurs during braking via an electric motor that operates as a generator to restore power to a battery or other energy storage device. As commonly known, vehicles equipped with regenerative braking systems may also have anti-lock braking systems (ABS) that improve vehicle control and stability in the event of wheel slip. However, when a wheel slip condition occurs, the anti-lock brake system customarily causes disengagement of the regenerative braking system. Consequently, the vehicle operator experiences a lunge forward feeling due to the instantaneous loss of braking torque and deceleration. This sudden loss of deceleration is undesirable to the vehicle operator.

Thus, the present invention was conceived in view of these and other disadvantages of regenerative braking systems.

### SUMMARY

The present invention includes a system and method for controlling a regenerative braking system of a vehicle having multiple wheels. The method includes applying a regenerative braking torque to at least one wheel. The method includes determining whether a second wheel of a vehicle is experiencing an anti-lock braking system (ABS) event. The method also includes compensating, at a determined rate, the regenerative braking torque applied to the one wheel upon determining that the second wheel of the vehicle is experiencing the ABS event.

The system includes a vehicle having multiple wheels and a regenerative braking system. The vehicle is configured to apply regenerative braking torque to at least one wheel. The vehicle is configured to determine that at least a second wheel is experiencing an ABS event. Additionally, the vehicle is configured to compensate, at a predetermined rate, the regenerative braking torque applied to the one wheel upon determining that the second wheel of the vehicle is experiencing the ABS event.

The above embodiments and other embodiments, features and advantages of the present invention are readily apparent from the following detailed description of the best mode for carrying out the invention when taken in connection with the accompanying drawings.

### BRIEF DESCRIPTION OF THE DRAWINGS

The features of the present invention, which are believed to be novel, are set forth with particularity in the appended claims. The present invention, both as to its organization and manner of operation, together with further objectives and advantages thereof, may be best understood with reference to the following description, taken in connection with the accompanying drawings in which:

FIG. 1 illustrates a vehicle having a regenerative braking system according to an embodiment of the present invention; and

FIG. 2 illustrates a flow diagram for a method for controlling a regenerative braking system in accordance with an embodiment of the present invention.

### DETAILED DESCRIPTION OF AN EMBODIMENT OF THE INVENTION

By way of example, a system and method for implementing the present invention is described below. The system and methodology may be adapted, modified or rearranged to best fit a particular implementation without departing from the scope of the present invention.

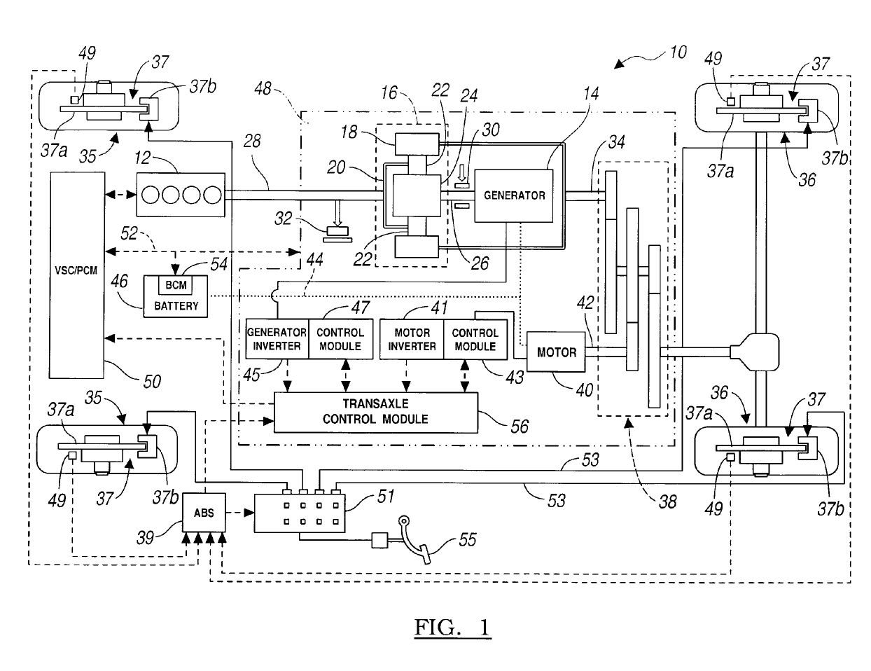

FIG. 1 illustrates a schematic representation of a vehicle 10 in accordance with one embodiment of the present invention. The vehicle 10 includes an engine 12 and an electric machine, or generator 14. The engine 12 and the generator 14 are connected through a power transfer unit, which in this embodiment is a planetary gear set 16. Of course, other types of power transfer units, including other gear sets and transmissions, may be used to connect the engine 12 to the generator 14. The planetary gear set includes a ring gear 18, a carrier 20, planet gears 22, and a sun gear 24.

The generator 14 can also be used as a motor, outputting torque to a shaft 26 connected to the sun gear 24. Similarly, the engine 12 outputs torque to a shaft 28 connected to the carrier 20.

A brake 30, may be, but not necessarily provided for stopping rotation of the shaft 26, thereby locking the sun gear 24 in place. Because this configuration allows torque to be transferred from the generator 14 to the engine 12, a one-way clutch 32 may be provided so that the shaft 28 rotates in only one direction. Having the generator 14 operatively connected to the engine 12, as shown in FIG. 1, allows the speed of the engine 12 to be controlled by the generator 14. It is recognized that alternative embodiments may not include brake 30 and/or clutch 32.

The ring gear 18 is connected to a shaft 34, which is connected to rear vehicle drive wheels 36 through a second gear set 38. Additionally, the vehicle 10 includes a set of front wheels 35 that may be directly coupled to engine 12. The vehicle 10 includes a second electric machine, or motor 40, which can be used to output torque to a shaft 42. Other vehicles within the scope of the present invention may have different electric machine arrangements, such as more or less than two electric machines. In the embodiment shown in FIG. 1, the motor 40 and the generator 14 can both be used as motors to output torque. Alternatively, each can also be used as a generator, outputting electrical power to a high voltage bus 44 and to an energy storage device, or battery 46.

The battery 46 is a high voltage battery that is capable of outputting electrical power to operate the motor 40 and the generator 14. Other types of energy storage devices and/or output devices can be used with a vehicle, such as the vehicle 10. For example, a device such as a capacitor can be used, which, like a high voltage battery, is capable of both storing and outputting electrical energy. Alternatively, a device such as a fuel cell may be used in conjunction with a battery and/or capacitor to provide electrical power for the vehicle 10.

As shown in FIG. 1, the motor 40, the generator 14, the planetary gear set 16, and a portion of the second gear set 38 may generally be referred to as a transaxle 48. The transaxle 48 is analogous to a transmission in a conventional vehicle. Thus, when a driver selects a particular gear, the transaxle 48 is appropriately controlled to operate according to the gear selection. To control the engine 12 and the components of the transaxle 48—e.g., the generator 14 and motor 40—a control system, including a first controller 50, is provided. As shown in FIG. 1, the controller 50 is a combination vehicle system controller and powertrain control module (VSC/PCM). Although it is shown as a single hardware device, it may include multiple controllers in the form of multiple hardware devices, or multiple software controllers within one or more hardware devices. The controller 50 logic, including logic associated with other controllers (e.g., TCM 56) may be partitioned in any number of ways without imposing any limitation on the claimed invention.

A controller area network (CAN) 52 allows the controller 50 to communicate with the transaxle 48 and a battery control module (BCM) 54. Just as the battery 46 has the BCM 54, other devices controlled by the controller 50 may have their own controllers. For example, an engine control unit (ECU) may communicate with the controller 50 and may perform control functions on the engine 12. In addition, the transaxle 48 may include one or more controllers, such as a transaxle control module (TCM) 56, configured to control specific components within the transaxle 48, such as the generator 14 and/or the motor 40. Accordingly, as shown in FIG. 1, the TCM 56 communicates with a generator inverter 45 and a motor inverter 41. In one embodiment, the generator inverter 45 and the motor inverter 41 are coupled to a control module 47 and a control module 43, respectively. Control modules 43 and 47 are capable of converting raw vehicle sensor data readings to a format compatible with the TCM 56 and sending those readings to the TCM 56.

Although the vehicle 10, shown in FIG. 1, is a HEV, it is understood that the present invention contemplates the use of other types of vehicles. In addition, although the vehicle 10 shown in FIG. 1 is a parallel-series HEV, the present invention is not limited to HEV's having such a “powersplit” configuration. Furthermore, although the vehicle 10 is illustrated having a single motor (i.e., motor 40), other embodiments may include additional motors without departing from the scope of the present invention. Thus, the present invention is applicable to an alternative embodiment of vehicle 10 having a motor, such as motor 40, coupled directly to a front axle (not shown) of front wheels 35. Additionally, in alternative embodiments vehicle 10 may be a fuel-cell vehicle without departing from the scope of the present invention.

As shown, vehicle 10 further includes friction brakes 37. Brakes 37 include a brake disc 37a, a caliper 37b, and a speed sensor 49 that communicates with an anti-lock braking system (ABS) module 39. Caliper 37b is operable with brake disc 37a for slowing and/or stopping vehicle 12. ABS module 39 is operable with a pressure adjustment unit 51. In response to a brake request from a brake pedal 55, pressure adjustment unit 51 is configured to enable proper distribution of braking fluid pressure to brakes 37 through the use of liquid pressure passages 53. Although the embodiment shown in FIG. 1 illustrates a braking system that utilizes hydraulics, it is recognized that the friction braking system of FIG. 1 may be a pure brake-by-wire (BBW) system, an electro-mechanical braking system, an electro-hydraulic braking system, or a hydro-mechanical braking system without departing from the scope of the present invention. In either embodiment, ABS module 39 is operable with controller 50 and TCM 56 for monitoring and controlling the performance of the generator 14 and the motor 40.

In the event wheels 35 enter ABS control via ABS module 39, during active regenerative braking, the torque generated by the motor 40 and/or the generator 14 is compensated. Compensation of the braking torque occurs in a manner so as to minimize the driver's perception of loss of deceleration. In one embodiment, the torque generated by the motor 40 and the generator 14 is reduced in a controlled manner at a determined rate. Accordingly, the reduction in torque mitigates any “lunge forward” feeling experienced by vehicle occupants when wheels 35 enter ABS mode and regenerative braking is reduced. In one embodiment, the ABS module 39 and the speed sensor 49 detect a potentially locking wheel slip event experienced by the front wheels 35. It is recognized that the term “wheel slip” herein refers to any condition which causes the engagement/activation of the ABS.

Upon detection of the wheel slip event (i.e., activation of ABS control) by front wheels 35, the ABS module 39 generates a signal for the TCM 56 that indicates the occurrence of ABS activation. As such, the TCM 56 is configured to generate signals for a controlled reduction of regenerative braking torque being applied to rear wheels 36 by the motor 40 and the generator 14. Thus, when the rear wheels 36 reach the road surface location where the front wheels 35 experienced the wheel slip condition, the torque has been reduced in a manner that mitigates the “lunge forward” feeling that is caused by conventional regenerative braking systems. Consequently, when the ABS system is activated for the rear wheels 36, any subsequent reduction in regenerative applied torque is less noticeable to the vehicle occupants.

In the event the ABS system is not activated within a determined time period for the rear wheels 36, the amount of regenerative braking torque allowed at the rear wheels 36 may be increased. Furthermore, in the event the vehicle 10 stops or begins accelerating, the TCM 56 generates signals for the generator 14 and the motor 50 to enable the application of an additional amount of torque to the rear wheels 36. In one aspect of the present invention, the amount of added regenerative braking torque is equivalent to the original unreduced amount of regenerative braking torque.

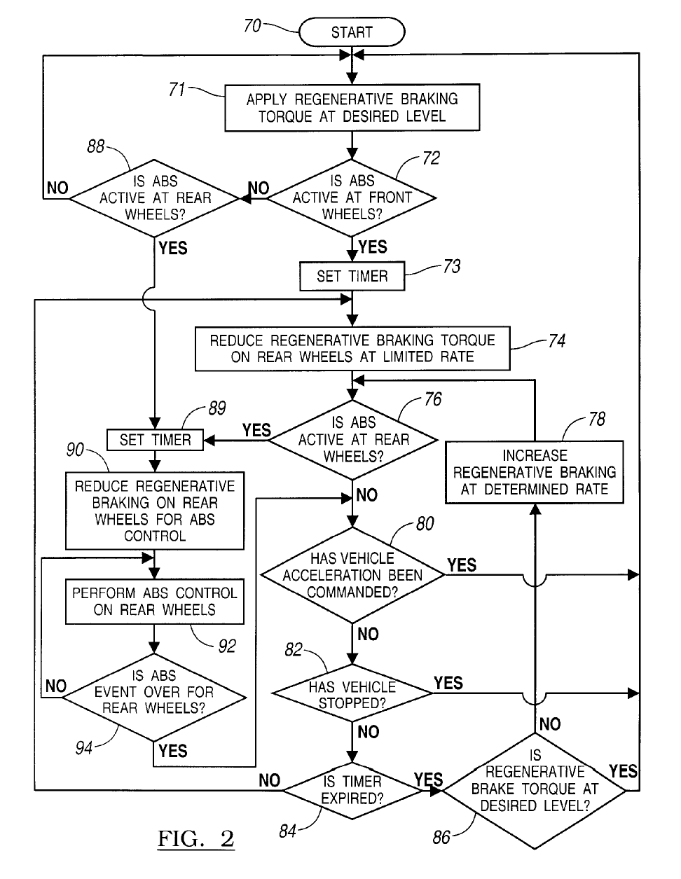

Now, referring to FIG. 2, a flow diagram is shown that illustrates a method for controlling the application of regenerative braking torque generated by the generator 14 and the motor 50. As described above, the torque generated by the generator 14 and/or the motor 50 provides motive force to the vehicle. Accordingly, block 70 is the entry point for the method. As depicted by block 71, the method includes applying regenerative braking torque at a desired level. As described in the foregoing, the generator and/or motor of the vehicle are capable of providing regenerative braking torque. Block 72 depicts the determination of whether the ABS system has been engaged for the front wheels of the vehicle. If the ABS system has been activated, a timer is set as shown by block 73. It is recognized that in some instances it is possible for the front wheels of the vehicle to experience an ABS event, while the rear wheels do not experience an ABS event. As such, the time for which the timer is set may be dependent upon the vehicle wheel base and speed of the vehicle. In an alternative embodiment, the time for which the timer is set may be a predetermined time period, including, but not limited to one minute or less. In yet another embodiment the predetermined time period may be greater than one minute.

As shown by block 74, the method reduces the regenerative braking torque applied to the rear wheels at a determined rate. Block 76 depicts the determination of whether the ABS system has been activated at the rear wheels. If the ABS system has not been activated, block 80 occurs. At block 80, the method determines whether the vehicle has received an acceleration command via the vehicle's accelerator pedal. If the vehicle has not received an acceleration command, block 82 occurs. At block 82, the method determines whether the vehicle has stopped. If the vehicle has not stopped, step 84 occurs, wherein the method determines whether the timer originally set at block 73, has expired. If the timer has expired, the method determines whether the regenerative braking torque is at a desired level as shown by block 86. If the regenerative braking torque is not at a desired level, block 78 occurs. At block 78, the regenerative braking torque is increased at a determined rate. At block 78, the increase in regenerative braking torque occurs in a manner that is minimally noticeable, if not completely unnoticeable by vehicle occupants. If the regenerative braking torque is at a desired level, the method returns to block 71. Referring back to block 80, if the vehicle acceleration has been commanded, the method returns to block 71. Referring to block 82, if the vehicle has stopped, the method also returns to block 71. Referring to block 84, if the timer has not expired, the method returns to block 74.

Now, referring back to block 72, if the ABS system has not been activated at the front wheels, block 88 occurs. At block 88, the method determines whether the ABS has been activated at the rear wheels. If the ABS system has not been activated at the rear wheels, the method returns to block 71. In the event the ABS has been activated at the rear wheels, block 89 occurs. At block 89, the timer may be set. In one aspect, if the timer was set at block 73 and has not yet expired, the timer may be re-initialized at block 89. In one embodiment, the time for which the timer is set may be a predetermined time period, including, but not limited to one minute or less. In yet another embodiment the predetermined time period may be greater than one minute. At block 90, the method reduces the regenerative braking torque applied to the rear wheels for ABS control. Additionally, referring to block 76, if the ABS is active at the rear wheels, the method sets the timer as depicted by block 89. Accordingly, block 90 occurs wherein the method reduces the regenerative braking on the rear wheels for ABS control. Block 92 depicts the performance of ABS control on the rear wheels. As shown by block 94, the method determines whether the ABS event is over. If the ABS event has not ended, the method returns to block 92. If the ABS event has ended, the method returns to block 80. In alternative embodiments, the regenerative braking torque may be increased (e.g., block 78) without waiting for the timer to expire in the event the rear wheels have experienced an ABS event that has ended (as determined at block 94).

While the best mode for carrying out the invention has been described in detail, those familiar with the art to which this invention relates will recognize various alternative designs and embodiments for practicing the invention as defined by the following claims.

What is claimed is:

1. A method of controlling a vehicle having multiple wheels and a regenerative braking system for applying a braking torque to the wheels, the method comprising:
applying a braking torque to one wheel;
determining whether a second wheel is experiencing an anti-lock braking system (ABS) event;
compensating, at a determined rate, the braking torque applied to the one wheel upon determining whether the second wheel is experiencing the ABS event.

2. The method according to claim 1, further comprising:
determining whether the one wheel is experiencing an ABS event.

3. The method according to claim 2, further comprising applying braking torque to the one wheel upon determining that the ABS event has ended.

4. The method according to claim 1, wherein compensating, at the determined rate, the braking torque applied to the one wheel includes reducing the braking torque applied to the one wheel.

5. The method according to claim 1, wherein the second wheel includes a set of front wheels of the vehicle.

6. The method according to claim 1, wherein the one wheel includes a set of rear wheels of the vehicle.

7. A vehicle having multiple wheels and a regenerative braking system for applying a braking torque to the wheels, the vehicle being configured to:
apply a braking torque to one wheel;
determine whether at least a second wheel is experiencing an anti-lock braking system (ABS) event; and
compensate, at a determined rate, the regenerative braking torque applied to the one wheel upon determining that the first wheel is experiencing the ABS event.

8. The vehicle according to claim 7, wherein the vehicle is further configured to:
determine whether the one wheel is experiencing an ABS event.

9. The vehicle according to claim 8, wherein the vehicle is further configured to enable the application of regenerative braking torque to the one wheel upon determining that the ABS event has ended.

10. The vehicle according to claim 7, wherein the vehicle being configured to compensate, at the determined rate, the regenerative braking torque applied to the one wheel includes the vehicle being configured to reduce the regenerative braking torque applied to the one wheel.

11. The vehicle according to claim 7, wherein the vehicle is configured to determine whether the second wheel is experiencing an ABS event includes the vehicle being configured to determine whether an anti-lock braking (ABS) event has occurred.

12. The vehicle according to claim 8, wherein the second wheel includes a set of front vehicle wheels.

13. The vehicle according to claim 8, wherein the one wheel includes a set of rear vehicle wheels.

14. A method of controlling a regenerative braking system for a hybrid-electric vehicle having a set of front and rear wheels and a motor and/or generator, the method comprising:
applying regenerative braking torque to the rear wheels;
determining whether the front wheels are experiencing an anti-lock braking system (ABS) event, through the use of an anti-lock braking system; and
compensating, at a determined rate, the regenerative braking torque being applied to the rear wheels upon determining that the front wheels are experiencing the ABS event, wherein the regenerative braking torque is generated by the motor and/or generator.

15. The method according to claim 14, wherein compensating, at the determined rate, the regenerative braking torque being applied to the rear wheels includes reducing the braking torque applied to the rear wheels.

16. The method according to claim 14, further comprising:
determining whether the rear wheels are experiencing an ABS event; and
compensating the regenerative braking torque applied to the rear wheels upon determining that the rear wheels are experiencing the ABS event.

17. The method according to claim 16, wherein compensating the braking torque applied to the rear wheels includes substantially reducing the regenerative braking torque being applied to the rear wheels.

18. The method according to claim 16, further comprising:
applying regenerative braking torque to the rear wheels upon determining that the ABS event has ended.

19. The method according to claim 18, wherein the regenerative braking torque applied to the rear wheels is applied subsequent to the expiration of a timer.
